(19) United States
(12) Patent Application Publication
(10) Pub. No.: US 2006/0225325 A1
(43) Pub. Date: Oct. 12, 2006

(54) Display device, product holder element and dividing member

(76) Inventor: Thomas Gijsbert Paulen, Eindhoven (NL)

Correspondence Address: YOUNG & THOMPSON, 745 SOUTH 23RD STREET, 2ND FLOOR, ARLINGTON, VA, 22202, US

(21) Appl. No.: 11/392,672

(22) Filed: Mar. 30, 2006

(30) Foreign Application Priority Data
Mar. 30, 2005 (NL) 1 028 654

(51) Int. Cl. G09F 11/02

(52) U.S. Cl. 40/503

(57) ABSTRACT

A display device comprises at least a first and a second revolving product stand (11,12) which are both rotatable about a vertical shaft (13). The first and second revolving product stands both comprise a product column, constructed in a further aspect of the invention from separate product holder elements (30), with an at least substantially polygonal cross-section transversely of the shaft, which are mounted rotatably about an axis of the shaft of the revolving product stand. The revolving product stands are placed on a shared base (10), wherein a coupling (17) exists between the shafts of the revolving product stands so that the rotations of the revolving product stands about an individual axis correspond to each other. A dividing member (40) can be arranged in the product holder elements in order to realize a subdivision into separate shelves.

The present invention relates to a display device, comprising at least two freely rotatable, i.e. not motor-driven, revolving product stands which both comprise a product column, with an at least substantially polygonal cross-section transversely of a vertical axis thereof, which product column is arranged freely rotatably about the vertical axis. The invention also relates to a product holder and dividing element for application in such a display device.

A display device of the above stated type can be particularly applied for displaying and exhibiting products such as diverse types of article and paper products at for instance trade fairs, markets and in shops. Particularly in a shop environment it is of great importance here that as many products as possible can be displayed in clearly visible manner on the smallest possible floor area. With a view hereto the display device provides a multisided revolving product stand or stand which provides space on all sides to products for displaying, which are herein arranged for instance next to each other and above each other. In known display devices these are individual, standalone revolving product stands which are placed next to each other or at least together. The revolving stands herein maintain a sufficient mutual distance to allow a free rotation about their axiss.

A drawback of such a known arrangement is that, in order to be able to guarantee an unimpeded rotation of the individual revolving stands under all circumstances, an intermediate space must be maintained therebetween which space is thereby not available for products. This has an adverse effect on the degree of utilization of the available floor surface area.

The present invention has for its object, among others, to provide a display device whereby a more optimal use can be made of an available space.

In order to achieve the intended object a display device of the type stated in the preamble has the feature according to the invention that the revolving product stands are placed on a shared base and that a coupling exists between the shafts of the revolving product stands, whereby rotations of the revolving product stands correspond to each other. By thus making the rotations of the separate revolving product stands correspond to each other and fixing the revolving product stands on a shared base the mutual distance between the revolving stands can be kept to a minimum, while mutual collision is nevertheless precluded. This correspondence can for instance consist of a blocking or fixation of one of the revolving stands in a starting position when the other one is moved. In a particular embodiment the display device according to the invention has the feature however that the coupling comprises a one-to-one transmission. A rotation of one of the revolving product stands thus results in the same rotation of the other revolving product stand(s) so that the products situated therein are likewise shown to the public.

Owing to the coupling the revolving stands herein move in phase with each other in each case and are not in opposite phase, whereby a mutual collision can be avoided even at a mutual pitch equal to a width of one of the sides of the revolving stands. In a further particular embodiment the display device according to the invention herein has the feature that the transmission comprises a toothed belt. Such a toothed belt has the advantage that, even after years of use, no play occurs herein, or hardly so, while the costs thereof are relatively low.

A preferred embodiment of the display device according to the invention has the feature that the revolving product stand herein provides space for products on each triangle side and is found in practice to provide an exceptionally good view of the products present therein.

A particular embodiment of the display device according to the invention herein has the feature that the revolving product stands have at least one rest position in which triangle sides of the revolving product stands lie at least substantially mutually in line and to which the revolving product stands return after a rotation. The rest position can herein be actively imposed by for instance a torsion spring which engages on the shaft of the revolving product stand, or passively by means of for instance a rise profile or screw thread in which the revolving stand rises when rotated and then drops automatically under the influence of gravity. The rest position ensures in each case a defined starting position, whereby the appearance of the revolving product stands will always be well-ordered and the products are displayed optimally. In a further particular embodiment the display device according to the invention is herein characterized in that the triangle sides are situated on a rear side of the revolving product stands. In this case a visual side of the revolving stands provides a prismatic view at all times of two triangle sides per revolving stand, whereby all products are always visible on these two sides.

A further particular embodiment of the display device according to the invention has the feature that the revolving product stands are placed in a row and that a rear wall is placed at least substantially parallel thereto, which extends over at least a significant part of a height and width formed by the revolving product stands. The rear wall herein provides a setting for the display device, which is hereby less dependent on the immediate surroundings for an optimal presentation of the products accommodated therein. The rear wall can furthermore be given a mirror form in order to provide a view from all sides of the products in the display device.

A further preferred embodiment of the display device has the feature that the product column is constructed from a number of mutually stacked, practically identical product holder elements of a substantially polygonal cross-section directed transversely of the shaft with polygonal sides, that the product holder elements comprise a product holder on each polygonal side for receiving one or more products, and that the product holder elements comprise an opening inside the polygonal sides for receiving the shaft of the revolving product stand therein. The revolving product stand is herein assembled substantially of uniform, mutually stackable product holder elements, which can here be placed on top of each other to any desired height. Not only is such a modular construction a great advantage from a production viewpoint, it also improves the flexibility and utility thereof for the end user. This latter need only hold a sufficient number of separate product holder elements in stock, and can hereby assemble different heights and types of display device in accordance with his/her possibly temporary requirements. These are not only display devices of the above stated type, wherein the products are always disposed rotatably about a shaft. The invention also relates to a display device comprising at least one product stand for receiving a number of products around a shared shaft, which is characterized in that the product stand is constructed from a number of mutually stacked, practically identical product holder elements with a substantially polygonal cross-section with polygonal sides directed transversely of the shaft, and that the product holder elements comprise on each polygonal side a product holder for receiving one or more products. Such a stand can also be used statically, in addition to rotating as a revolving stand. The modular construction here also provides the option of construction to any desired height and of stocking only a limited supply of product holder elements.

A preferred embodiment of the display device according to the invention herein has the feature that the product holder elements comprise an opening inside the polygonal sides for receiving therein a separate, non-round shaft of the stand. By thus using a non-round shaft and sliding the product holder elements thereon, the product holder elements are fixed in at least a horizontal plane and so exactly aligned relative to each other. This facilitates the mutual stacking and enhances the stability of the whole. In a further particular embodiment the display device herein has the feature that the shaft extends rotatably from a base. The stand thus provides a revolving product stand or carousel which provides a view of the products on all sides by means of rotation.

In order to increase the stability of the whole and mutual fixation of the separate elements, a further preferred embodiment of the display device according to the invention has the feature that the product holder elements are nested in each other over a small part of their height.

A particular embodiment of the display device according to the invention has the feature that product holders of the product holder elements comprise an open compartment on each polygonal side for receiving one or more products therein. The compartments form trays in which products can be removably accommodated. In order to enable a certain further subdivision here, a further particular embodiment of the display device according to the invention has the feature that the compartments are divided into separate shelves in a width direction by at least one dividing member. The dividing members can be arranged in the compartments in a number and position as desired in order to thus create therein separate shelves on either side, in which different products can be placed.

A further particular embodiment of the display device according to the invention herein has the feature that the compartments comprise a rear wall and the dividing member is hooked over the rear wall by a fixing member extending therefrom. The largest possible part of the height of larger products preferably protrudes above the compartment so as to thus be more readily visible. In order to prevent such products from falling out, a further particular embodiment of the display device according to the invention has the feature that the dividing member comprises a stop member on a side remote from the rear wall for receiving a product thereagainst.

A particularly attractive and effective presentation of the products received in the stand is found possible with a particular embodiment of a display device according to the invention, characterized in that the product holder elements have a substantially triangular, more specifically equilateral cross-section.

The invention also relates to a product holder element and dividing member as described above and will be further elucidated on the basis of a number of exemplary embodiments and an associated drawing. In the drawing:

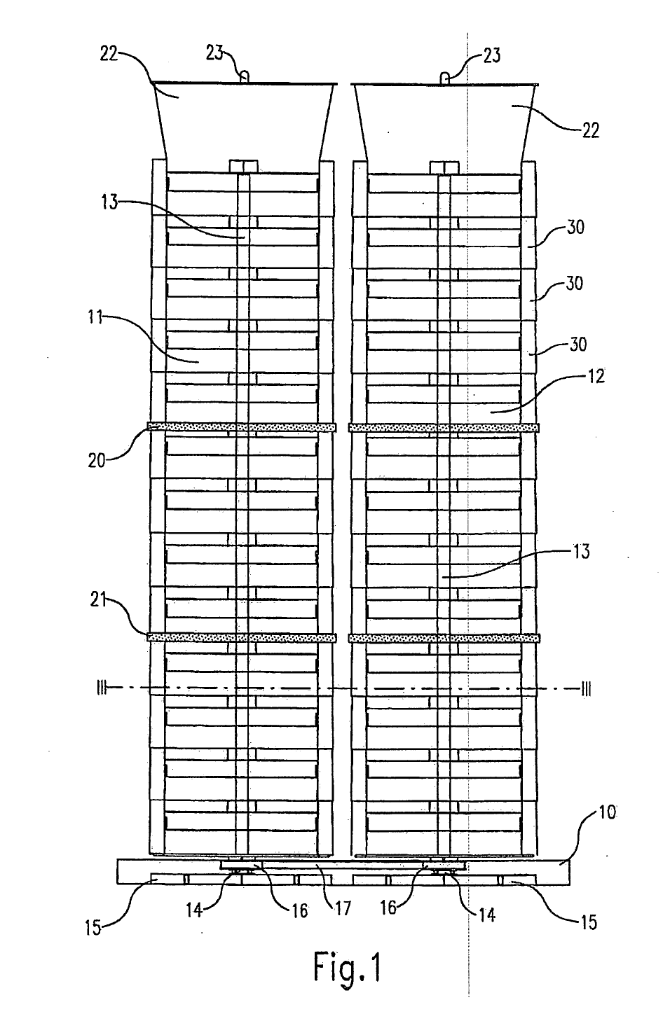

FIG. 1 shows a front view of a first embodiment of a display device according to the invention;

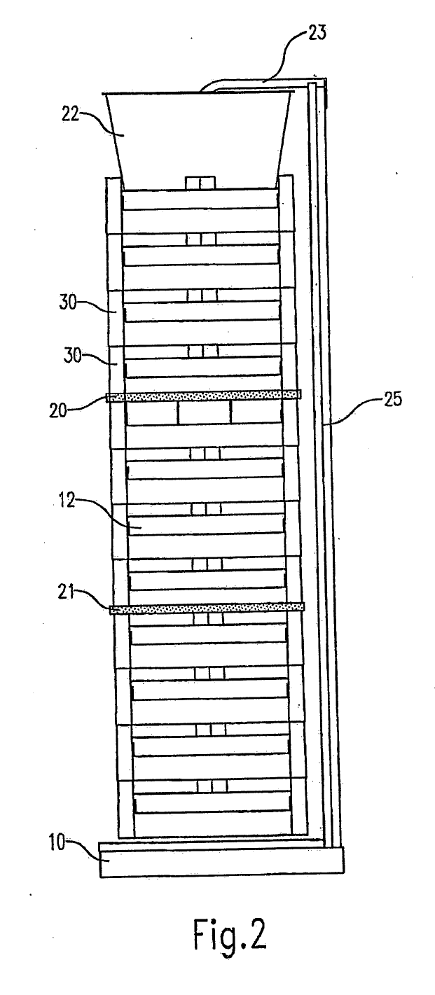

FIG. 2 shows a side view of the device of FIG. 1;

FIG. 3 shows a cross-section of the device of FIG. 1;

FIG. 4 shows a front view of a product holder element as applied in the device of FIG. 1;

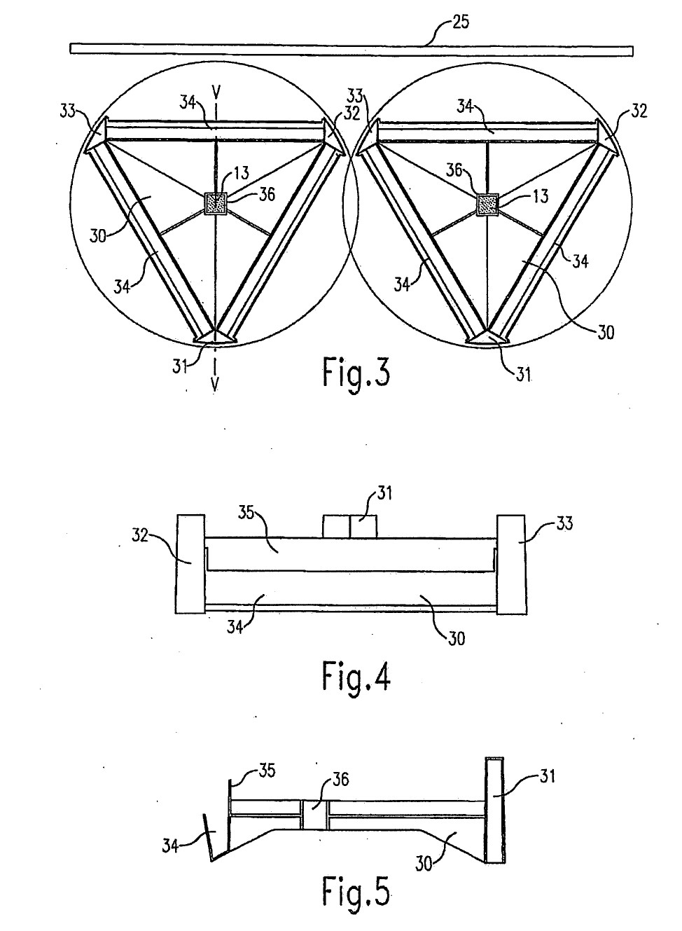

FIG. 5 shows a cross-section of the product holder element of FIG. 4;

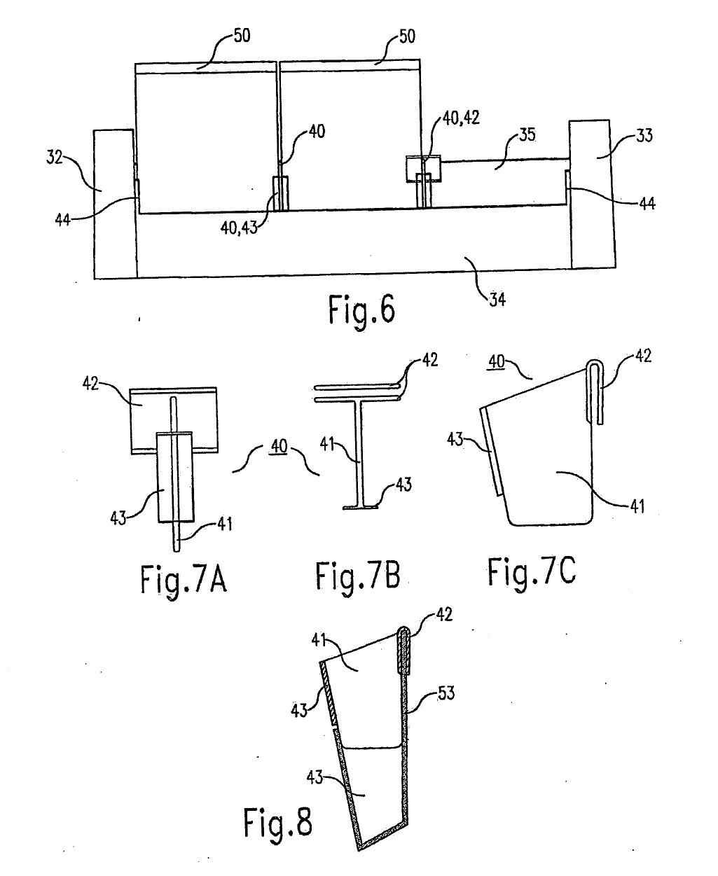

FIG. 6 shows a front view of the product holder element of FIG. 4 in filled state;

FIG. 7A shows a front view of a dividing member as applied in the product holder element of FIG. 6;

FIG. 7B shows a first cross-section of the dividing member as applied in the product holder element of FIG. 6;

FIG. 7C shows a second cross-section of the dividing member as applied in the product holder element of FIG. 6;

FIG. 8 shows a cross-section of the product holder element of FIG. 6 having therein the dividing member of FIGS. 7A-7C;

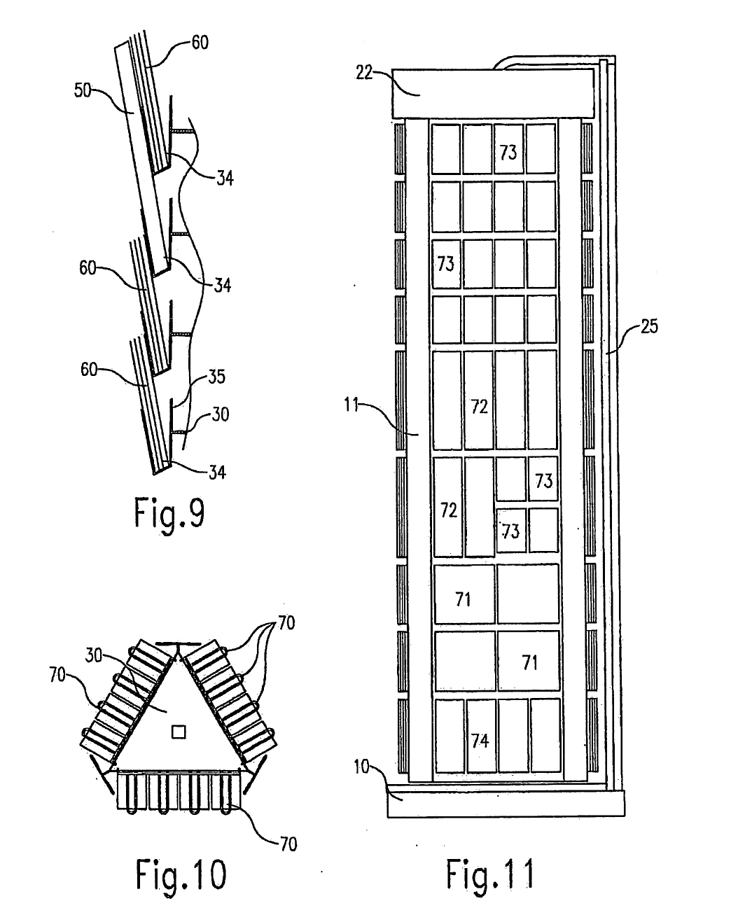

FIG. 9 shows a cross-section of the product holder of FIG. 6 in filled state;

FIG. 10 shows a cross-section of a second embodiment of a product holder element according to the invention; and

FIG. 11 shows a side view of a second embodiment of a display device according to the invention on the basis of the product holder element of FIG. 10.

The figures are in principle schematic and not always drawn to scale. Some dimensions in particular can be exaggerated to a greater or lesser extent for the sake of clarity. Corresponding parts are designated in the figures with the same reference numeral.

A display device according to the invention is shown in front view in FIG. 1 and in side view in FIG. 2. The device comprises two revolving product stands 11,12 extending from a shared base 10. Both revolving stands 11,12 have a substantially polygonal cross-section and are constructed around a vertical central shaft 13, wherein shaft 13 is rotatably connected to a baseplate 15 by means of a bearing 14. Mounted on both shafts 13 close to baseplate 15 is a toothed wheel 16, over which a toothed belt 17 is received which couples, and thus correspondingly drives, a rotation of the two shafts one-to-one. Both the baseplates and the belt transmission are hidden from view by a closed housing of base 10, which thus forms a plinth for the whole. With an eye to a desired robustness and durability, both the shafts 13 and the toothed wheels, baseplates 15 and casing 10 are manufactured from steel. Otherwise the revolving product stand consists mainly of plastic. In addition, the coupling between both shafts can also comprise a toothed wheel, chain or V-belt transmission instead of an optionally toothed belt transmission, and a certain indirect coupling can be applied here if desired, whereby the one revolving stand co-rotates over a certain offset angle only after a rotation of the other revolving stand.

Both revolving product stands have a modular construction through a stacking of individual product holder elements 30 on the central shaft, see also FIG. 3 which shows a cross-section along line III-III of FIG. 1. In this example the product holder elements have an equilateral triangular cross-section and are placed separately on shaft 13. A three-sided column providing equal space to products on all sides can thus be assembled to a desired height. Provided all around on both columns 11,12 is a bar handle 20, with which the column can be rotated, as well as a bumper 21 which provides protection from shopping carts, prams, wheelchairs and the like. Columns 11,12 are finished with a round tube 22 which provides space for text or decoration and is connected to a rear wall by means of a bracket 23 for the purpose of an increased stability of the whole.

The shafts of both revolving product stands 11,12 are both provided with resetting means which always return the revolving product stands to a rest position after rotation. The resetting means are here formed by a set of oppositely rotating discs (not shown) in shaft 13, which force the revolving product stand upward during rotation and drive them back to a starting position under the influence of gravity. Diverse other active and passive solutions having the same or a similar effect can be selected. As a result of such an automatic resetting the display device will always return to an orderly starting position, which gives an orderly appearance and furthermore presents the products as optimally as possible.

In FIG. 1 a starting position is chosen in which two triangle sides of both columns 11,12 lie mutually in line, see also FIG. 3, and together form a practically continuous front which provides a full view of the products present on these sides. FIG. 3 is on the other hand based on a more prismatic view of columns 11,12 in which in the rest position the sides lying in line are situated here on a rear side, and the columns face toward the viewer with a corner. Although there is thus less of a view of the products from the front than in a frontal view as in FIG. 1, more products are in this way presented simultaneously.

Product holder elements 30 are shown in more detail in FIGS. 3-5 and are each moulded substantially integrally from a suitable plastic such as polyethylene, polypropylene or ABS. Plastic elements 30 comprise a relatively solid central part with the desired polygonal cross-section, in this case of an equilateral triangle. Situated at the corners of the central part are slightly rounded column-like parts 31-33, while the sides of the central part provide space for product holders 34 in which or on which the products for displaying can be received. On each side the product holders here comprise a compartment 34 with a rear wall 35.

Column-like parts 31-33 are given a hollow and slightly conical form. Product holder elements 30 are thus mutually stackable, wherein at the position of at least the column-like parts 31-33 the elements nest in each other slightly for a stable and aligned stacking. The product holder elements are moreover fixed on shaft 13 of the revolving stand by non-round opening 36 and likewise shaft 13.

Compartments 34 provide space for separate products. If desired, compartments 34 can be divided in separate shelves by placing one or more dividing members 40 therein, see FIGS. 6-8. Dividing members 40 are moulded integrally from one plastic and comprise a partition 41 which, using a clip 42 formed thereon, can be hooked over rear wall 35 of the compartments. The dividing member is then placed or slid into the desired position on the rear wall. If desired, recesses and complementary ribs or projections can be formed for this purpose in or on the rear wall and clip in order to define preferred positions corresponding to commonly occurring product sizes. In this example use is made of a compartment width of about 375 millimetres for receiving three CD cases 50 or postcards, or a standard DVD case and postcard or CD case next to each other as desired. A stop member 43 in the form of a widening on a front side of partition 41 herein prevents the cases or other products being able to fall out of compartment 34 unexpectedly. A comparable stop member 44 is formed on either side in compartment 34.

FIG. 9 shows schematically a number of product holder elements 30 of the device of FIG. 1 in filled state. Due to a relative vertical pitch of about 130 millimetres, or about the height of columns 31-33, of product holder elements 30 it is thus possible to place standard CD cases 50 and postcards 60 above each other and mixed with each other as desired. The display device is thus highly suitable for office stationers, bookshops, newspaper stands, record shops and related applications.

A second embodiment of a display device according to the invention is shown in FIGS. 10 and 11. The display device here also comprises a column-like revolving product stand 11 which is constructed from individual product holder elements, see FIG. 10, comparable to those of the first exemplary embodiment, although in this case the product holders comprise on the polygonal sides thereof product hooks 70 from which separate products 71,72,73,74 can be suspended. As shown in the view of FIG. 1, different sizes of blister packs or otherwise packaged products can thus be arranged in orderly fashion, wherein mutatis mutandis the display device has all the advantages and aspects of the above described display device.

Although the invention has been further elucidated with reference to only a few embodiments, it will be apparent that the invention is by no means limited thereto. On the contrary, many variations and embodiments are possible for the average skilled person within the scope of the invention.

1. Display device, comprising at least two freely rotatable revolving product stands which both comprise a product column, with an at least substantially polygonal cross-section transversely of a vertical axis thereof, which product column is arranged freely rotatably about the vertical axis, characterized in that the revolving product stands are placed on a shared base and that a coupling exists between the shafts of the revolving product stands, whereby rotations of the revolving product stands correspond to each other.

2. Display device as claimed in claim 1, characterized in that the coupling comprises a one-to-one transmission.

3. Display device as claimed in claim 2, characterized in that the transmission comprises a toothed belt.

4. Display device as claimed in claim 1, characterized in that the revolving product stands have a triangular cross-section, and more specifically that of a substantially equilateral triangle, transversely of the vertical shaft thereof.

5. Display device as claimed in claim 4, characterized in that the revolving product stands have at least one rest position in which triangle sides of the revolving product stands lie at least substantially mutually in line and to which the revolving product stands return after a rotation.

6. Display device as claimed in claim 5, characterized in that the triangle sides are situated on a rear side of the revolving product stands in the rest position.

7. Display device as claimed claim 1, characterized in that the revolving product stands are placed in a row and that a rear wall is placed at least substantially parallel thereto, which extends over at least a significant part of a height and width formed by the revolving product stands.

8. Display device as claimed claim 1, characterized in that the product column is constructed from a number of mutually stacked, practically identical product holder elements having transversely of the shaft a substantially polygonal cross-section with polygonal sides, that the product holder elements comprise a product holder on each polygonal side for receiving one or more products, and that the product holder elements comprise an opening inside the polygonal sides for receiving the shaft of the revolving product stand therein.

9. Display device comprising at least one product stand for receiving a number of products around a shared shaft, characterized in that the product stand is constructed from a number of mutually stacked, practically identical product holder elements with a substantially polygonal cross-section with polygonal sides directed transversely of the shaft, and that the product holder elements comprise on each polygonal side a product holder for receiving one or more products.

10. Display device as claimed in claim 1, characterized in that the product holder elements comprise an opening inside the polygonal sides for receiving therein a separate, non-round shaft of the stand.

11. Display device as claimed in claim 1, characterized in that the shaft extends rotatably from a base.

12. Display device as claimed in claim 1, characterized in that the product holder elements are nested in each other over a small part of their height.

13. Display device as claimed in claim 1, characterized in that product holders of the product holder elements comprise an open compartment on each polygonal side for receiving one or more products therein.

14. Display device as claimed in claim 13, characterized in that the compartments are divided into separate shelves in a width direction by at least one dividing member.

15. Display device as claimed in claim 14, characterized in that the compartments comprise a rear wall and the dividing member is hooked over the rear wall by a fixing member extending therefrom.

16. Display device as claimed in claim 1, characterized in that the dividing member comprises a stop member on a side remote from the rear wall for receiving a product there against.

17. Display device as claimed in claim 1, characterized in that the product holder elements have a substantially triangular, more specifically equilateral cross-section.

18. Display device as claimed in claim 1, characterized in that the product holder elements are formed substantially integrally from one moulded plastic part.

19. Product holder element for application in the display device as claimed in claim 1.

20. Dividing member for application in a product holder element of the display device as claimed in claim 1.
